(19) United States
(12) Patent Application Publication
(10) Pub. No.: US 2015/0218378 A1
(43) Pub. Date: Aug. 6, 2015

(54) ASPHALT ADDITIVE

(71) Applicant: Innophos, Inc., Cranbury, NJ (US)

(72) Inventor: Jean Valery Martin, Princeton, NJ (US)

(73) Assignee: Innophos, Inc., Cranbury, NJ (US)

(21) Appl. No.: 14/172,858

(22) Filed: Feb. 4, 2014

(51) Int. Cl. C08L 95/00; C08K 5/52; C08K 5/521; C08K 5/053

(52) U.S. Cl. CPC C08L 95/00; C08K 5/053; C08K 5/52; C08K 5/521

(57) ABSTRACT

The present disclosure relates to an additive for asphalt production, comprising phosphoric acid, polyphosphoric acid or mixtures thereof, and an alcohol. In some embodiments, the alcohol is glycerol.

### FIELD OF THE INVENTION

The present disclosure relates to an asphalt additive comprising phosphoric acid and an alcohol. The present disclosure also relates to a method of combining the additive to an asphalt mix. The additive promotes the in situ production of warm mix additive(s) in the asphalt mix. The presence of a warm mix additive(s) reduces the mixing and compaction temperature of asphalt mix materials.

### BACKGROUND OF THE INVENTION

There is an increasing concern in the asphalt industry about carbon emissions. The asphalt industry is actively seeking to decrease the production of such carbon emissions. The asphalt industry is also concerned with reducing energy cost. Both of these concerns have been driving the asphalt industry for the past 10 years.

As a result of such concerns, the asphalt industry has employed various processes to reduce both carbon emissions and energy costs. One such process seeks to reduce the mixing and compaction temperatures used with asphalt mixes. The process, called “warm mix”, uses lower temperatures in processing the asphalt mix. The use of lower temperatures, however, increases flow resistance. Therefore, the process also involves the addition of water, chemical additives or mixtures of both to reduce the flow resistance of the mix when processed at the lower temperature.

The addition of water typically requires the co-addition of an adhesion promoter to enhance the moisture resistance of asphalt mixes. The addition of chemical additives, including adhesion promoters, usually combine two functionalities (i) adhesion promotion and (ii) lubrication, to reduce the mixing and compaction temperature. Among the chemical additives used as adhesion promoters or warm mix additives are organic esters of phosphoric acid.

The addition of chemical additives significantly increases the asphalt mix price. The present disclosure relates to an alternative way to introduce warm mix additives/adhesion promoters into the asphalt mix to reduce the mixing and compaction temperature while not significantly increasing overall cost. This alternative method involves the production of the suitable chemical additives in situ while the asphalt is handled at a refinery or terminal.

### SUMMARY OF THE INVENTION

The present disclosure relates to an additive for asphalt production, comprising phosphoric acid, polyphosphoric acid or mixtures thereof, and an alcohol. In some embodiments, the alcohol is glycerol.

The present disclosure also relates to a method for improving asphalt production, comprising the step of combining an additive as described herein to an asphalt mix, wherein a warm mix additive/adhesion promoter is formed. In some embodiments, the promoter is an ester of phosphoric acid, or similar molecule.

The addition of the asphalt additive to an asphalt mix may result in a reduction of mixing and compaction temperatures from those typically used when preparing asphalt for raad pavements, an increase in the moisture resistance of asphalt mix, and/or an increase in the UTI (Useful Temperature Interval) of the asphalt or asphalt mix.

The useful temperature interval of asphalt is the differential, or spread in temperature, between the high temperature grading and the low temperature grading.

The use of phosphoric acids, e.g. polyphosphoric acid, is known in the asphalt industry. Phosphoric acids belong to a distinct family of chemical additives used to improve the stiffness of the asphalt at high temperature in order to provide a higher resistance to rutting to the asphalt mix produced with it. Phosphoric acids, and in particular phosphoric acids combined with an alcohol, have not been used to form in situ warm mix additive/adhesion promoter in asphalt mixes.

Conventional hot mix asphalt may be mixed at temperatures exceeding 300° F., e.g. 300-325° F., and may be paved and/or compacted at temperatures 5-20° F. cooler than the mix temperature. These temperatures, and other temperatures recited herein, may vary as a function of the starting asphalt grade material, related materials and other conditions.

The adhesive additive of the present disclosure may provide compositions that may be mixed with aggregate at temperatures 30-50° F. lower than, or more than 50° F. lower than, or as much as 100° F. lower than a substantially similar asphalt compositions, binder or cement that does not contain the adhesive additive. Similarly, the asphalt/aggregate mixtures can be compacted at temperatures 30-50° F. lower than, or more than 50° F. lower than, or as much as 100° F. lower than a substantially similar asphalt/aggregate mixture that does not contain the adhesive additive.

What is claimed is:

1. An additive for asphalt production, comprising
(i) phosphoric acid, polyphosphoric acid or mixtures thereof, and
(ii) an alcohol.

2. The additive of claim 1, wherein the alcohol is glycerol.

3. A method for improving asphalt production, comprising the step of:
(i) combining an additive of claim 1 to an asphalt mix, wherein a warm mix additive/adhesion promoter is formed.

4. The method of claim 3, wherein the promoter is an ester of phosphoric acid.

5. The method of claim 3, wherein the mixing and compaction temperature of the asphalt mix is reduced.

6. The method of claim 3, wherein the moisture resistance of the asphalt mix is increased.

7. The method of claim 3, wherein the useful temperature interval of the asphalt mix is increased.
